(19) United States
(12) Patent Application Publication
(10) Pub. No.: US 2007/0074893 A1
(43) Pub. Date: Apr. 5, 2007

(54) Calendered wrapping foil

(76) Inventor: Bernhard Müssig, Seevetal (DE)

Correspondence Address: NORRIS, MCLAUGHLIN & MARCUS, PA, 875 THIRD AVENUE, 18TH FLOOR, NEW YORK, NY, 10022, US

(21) Appl. No.: 10/573,399

(22) PCT Filed: Sep. 16, 2004
(86) PCT No.: PCT/EP04/52215

§ 371 Date: Nov. 21, 2006

(30) Foreign Application Priority Data
Oct. 14, 2003 (DE) 10348474.4

(51) Int. Cl. H01B 7/00

(52) U.S. Cl. 174/121 A

(57) ABSTRACT

A halogen-free calendered, and, in particular, flame-retardant polyolefin wrapping foil, characterized in that the melt index of the polyolefin is below 5 g/10 min, preferably below 1 g/10 min, and in particular below 0.7 g/10 min.

This application is a 371 of PCT/EP2004/055215, filed Sep. 16, 2004, which claims foreign priority benefit under 35 U.S.C. §119 of the German Patent Application No. 103 48 478.7 filed Oct. 14, 2003.

The present invention relates to a calendered halogen-free polyolefin wrapping foil which has been optionally provided with a pressure-sensitive adhesive coating and which is used, for example, for wrapping ventilation lines in air-conditioning units, wires or cables, and which is suitable in particular for cable harnesses in vehicles or field coils for picture tubes. This wrapping foil serves for bundling, insulating, marking, sealing or protecting. The invention further embraces processes for producing the foil of the invention.

Cable winding tapes and insulating tapes are normally composed of plasticized PVC film with a coating of pressure-sensitive adhesive on one side. There is an increased desire to eliminate disadvantages of these products.

The plasticizers in conventional insulating tapes and cable winding tapes gradually evaporate, leading to a health hazard; the commonly used DOP, in particular, is objectionable. Moreover, the vapors deposit on the glass in motor vehicles, impairing visibility (and hence, to a considerable extent, driving safety), this being known to the skilled worker as fogging (DIN 75201). In the event of even greater vaporization as a result of higher temperatures, in the engine compartment of vehicles, for example, or in electrical equipment in the case of insulating tapes, the wrapping foil is embrittled by the accompanying loss of plasticizer.

Plasticizers impair the fire performance of unadditized PVC, something which is compensated in part by adding antimony compounds, which are highly objectionable from the standpoint of toxicity, or by using chlorine- or phosphorus-containing plasticizers.

Against the background of the debate concerning the incineration of plastic wastes, such as shredder waste from vehicle recycling, for example, there exists a trend toward reducing the halogen content and hence the formation of dioxins. In the case of cable insulation, therefore, the wall thicknesses are being reduced, and the thicknesses of the PVC film are being reduced in the case of the tapes used for wrapping. The standard thickness of the PVC films for winding tapes is 85 to 200 μm. Below 85 μm, considerable problems arise in the calendering operation, with the consequence that virtually no such products with reduced PVC content are available.

The customary winding tapes comprise stabilizers based on toxic heavy metals, usually lead, more rarely cadmium or barium.

State of the art for the bandaging of sets of leads are wrapping foils with and without an adhesive coating, said foils being composed of a PVC carrier material which has been made flexible through incorporation of considerable amounts (30 to 40% by weight) of plasticizer. The carrier material is coated usually on one side with a self-adhesive mass based on SBR rubber. Considerable deficiencies of these adhesive PVC winding tapes are their low aging stability, the migration and evaporation of plasticizer, their high halogen content, and a high smoke gas density in the event of fire. JP 10 001 583 A1, JP 05 250 947 A1, JP 2000 198 895 A1 and JP 2000 200 515 A1 describe typical plasticized PVC adhesive tapes. In order to obtain higher flame retardancy in the platicized PVC materials it is usual, as described for example in JP 10 001 583 A1, to use the highly toxic compound antimony oxide.

There are attempts to use wovens or nonwovens instead of plasticized PVC film; however, the products resulting from such attempts are but little used in practice, since they are relatively expensive and differ sharply from the habitual products in terms of handling (for example, hand tearability, elastic resilience) and under service conditions (for example, resistance to service fluids, electrical properties), with—as set out below—particular importance being attributed to the thickness, since, not least, the rising number of consumer units is upping the diameter of cable strands. Some examples of textile adhesive tapes include the following:

DE 200 22 272 U1, EP 1 123 958 A1 and WO 99/61541 A1 describe adhesive winding tapes comprising a clothlike (woven) or weblike (nonwoven) carrier material. These materials are distinguished by a very high tensile strength. A consequence of this, however, is the disadvantage that, when being processed, these adhesive tapes cannot be torn off by hand without the assistance of scissors or knives.

Stretchability and flexibility are two of the major requirements imposed on adhesive winding tapes, in order to allow the production of crease-free, flexible cable harnesses. Moreover, these materials do not meet the relevant fire protection standards such as FMVSS 302. Improved fire properties can be realized only with the use of halogenated flame retardants or polymers as described in U.S. Pat. No. 4,992,331 A1.

Webs with this kind of thickness make the cable harnesses even thicker and more inflexible than conventional PVC tapes, albeit with a positive effect on soundproofing, which is of advantage only in certain areas of cable harnesses. Webs, however, lack stretchability and exhibit virtually no resilience. This is of importance on account of the fact that thin branches of cable harnesses must be wound with sufficient tautness that, when installed, they do not hang down loosely, and such that they can easily be positioned before the plugs are clipped on and attached. A further disadvantage of textile adhesive tapes is the low breakdown voltage of about 1 kV, since only the adhesive layer is insulating. Film-based tapes, in contrast, are situated at more than 5 kV; they have good voltage resistance.

Wrapping foils and cable insulation comprising thermoplastic polyester are being used on a trial basis for producing cable harnesses. They have considerable deficiencies in terms of their flexibility, processing qualities, aging stability or compatibility with the cable materials. The gravest disadvantage of polyester in addition to being flammable, however, is its considerable sensitivity to hydrolysis, which rules out use in automobiles on safety grounds.

DE 100 02 180 A1, JP 10 149 725 A1, JP 09 208 906 A1 and JP 05 017 727 A1 describe the use of halogen-free thermoplastic polyester carrier films. JP 07 150 126 A1 describes a flame-retardant wrapping foil comprising a polyester carrier film which comprises a brominated flame retardant.

Also described in the patent literature are winding tapes comprising polyolefins. These, however, are readily flammable or comprise halogenated flame retardants. Furthermore, the materials prepared from ethylene copolymers have too low a softening point (in general they melt even during an attempt to test them for stability to thermal aging), and in the case of the use of polypropylene polymers the material is too inflexible. The winding tapes described were produced by extrusion techniques, generally by the casting method (T-die) and, rarely, by blown-film extrusion. The described products therefore have increased contractions as compared with calendered or cast foils, and this can lead to telescoping in the rolls. For producers of PVC winding tapes another task which confronts them, when changing over to new, halogen-free winding tapes, is that of having to utilize fully the existing calender units. The proposed solutions for halogen-free winding tapes not only have a number of technical deficiencies but also offer no solution for the existing calender units.

WO 00/71634 A1 describes an adhesive winding tape whose film is composed of an ethylene copolymer base material. The carrier film comprises the halogenated flame retardant decabromodiphenyl oxide. The film softens below a temperature of 95° C., but the normal service temperature is often above 100° C. or even briefly above 130° C., which is not unusual in the case of use in the engine compartment.

WO 97/05206 A1 describes a halogen-free adhesive winding tape whose carrier film is composed of a polymer blend of low-density polyethylene with an ethylene/vinyl acetate or ethylene/acrylate copolymer. The flame retardant used is 20 to 50% by weight of aluminum hydroxide or ammonium polyphosphate. A considerable disadvantage of the carrier film is, again, the low softening temperature. To counter this the use of silane crosslinking is described. This crosslinking method, however, leads only to material with very nonuniform crosslinking, so that in practice it is not possible to realize a stable production operation or uniform product quality.

Similar problems of deficient heat distortion resistance occur with the electrical adhesive tapes described in WO 99/35202 A1 and U.S. Pat. No. 5,498,476 A1. The carrier film material described is a blend of EPDM and EVA in combination with ethylenediamine phosphate as flame retardant. Like ammonium polyphosphate, this flame retardant is highly sensitive to hydrolysis. In combination with EVA, moreover, there is an embrittlement on aging. Application to standard cables of polyolefin and aluminum hydroxide or magnesium hydroxide results in poor compatibility. Furthermore, the fire performance of such cable harnesses is poor, since these metal hydroxides act antagonistically with phosphorus compounds, as set out below. The insulating tapes described are too thick and too rigid for cable hardness winding tapes.

Attempts to resolve the dilemma between excessively low softening temperature and flexibility and freedom from halogen are described by the patents below. EP 0 953 599 A1 claims a polymer blend of LLDPE and EVA for applications as cable insulation and as film material. The flame retardant described comprises a combination of magnesium hydroxide of specific surface area and red phosphorus; however, softening at a relatively low temperature is accepted.

A very similar combination is described in EP 1 097 976 A1. In this case, though, for the purpose of improving the heat distortion resistance, the LLDPE is replaced by a PP polymer, which has a higher softening temperature. A disadvantage, however, is the resultant low flexibility. For blending with EVA or EEA it is maintained that the film has sufficient flexibility. From the literature, however, the skilled worker is aware that these polymers are blended with polypropylene in order to improve flame retardancy. The products described have a film thickness of 0.2 mm: this thickness alone rules out flexibility in the case of filled polyolefin films, since flexibility is dependent on the thickness to the 3rd power. With the extremely low melt indices of the polypropylenes used, as the skilled worker is aware, the described process of extrusion is virtually impossible to carry out on a production installation, and certainly not for a thin film in conformity to the art, and certainly not in the case of use in the combination with the high amounts of filler that are described.

Both attempted solutions build on the known synergistic flame retardancy effect of red phosphorus with magnesium hydroxide. The use of elemental phosphorus, however, harbors considerable disadvantages and risks. In the course of processing, foul-smelling and highly toxic phosphine is released. A further disadvantage arises from the development of very dense white smoke in the event of fire. Moreover, only brown to black products can be produced, whereas for color marking wrapping foils are used in a broad color range.

DE 203 06 801 U describes a polyurethane winding tape: such a product is much too expensive for the usual applications described above. There are no references to the use of aging inhibitors or magnesium hydroxide.

The stated patents of the prior art, in spite of the stated disadvantages, do not indicate films or foils which also meet the further requirements such as hand tearability, thermal stability, compatibility with polyolefin cable insulation, or adequate unwind force. Furthermore, the possibility of processing in film production operations, high fogging number, and the breakdown voltage resistance remain questionable. A film which can be produced by the calender method has not been found.

The object of the invention therefore remains that of finding a solution for a calendered wrapping foil which combines the mechanical properties (such as elasticity, flexibility, and hand tearability) of PVC winding tapes with the absence of halogen of textile winding tapes and, additionally, exhibits sufficient thermal aging resistance; at the same time, the possibility of industrial production of the foil on a soft PVC film unit ought to be ensured, and in certain applications high breakdown voltage resistance and high fogging number are desirable.

It is a further object of the invention to provide calenderable, halogen-free wrapping foils which allow particularly rapid and reliable wrapping, particularly of wires and cables, for the purpose of marking, protecting, insulating, sealing or bundling, where the disadvantages of the prior art do not occur, of at least not to the same extent.

In concert with the evermore complex electronics and the increasing number of electrical consumer units in automobiles, the sets of leads as well are becoming increasingly more complex. With increasing cable harness cross sections the inductive heating is becoming ever greater, while the dissipation of heat is reducing. As a result there are increases in the thermal stability requirements of the materials used. The PVC materials used as standard for adhesive winding tapes are reaching their limits here. A further object was therefore to find polypropylene copolymers with additive combinations which not only match but indeed exceed the thermal stability of PVC.

This object is achieved by means of a wrapping foil as described herein.

The amounts below in phr denote parts by weight of the component in question per 100 parts by weight of all polymer components of the foil. For a coated wrapping foil (with adhesive, for example) only the parts by weight of all polymer components of the polyolefin-containing layer are regarded.

The invention accordingly provides a halogen-free, calendered, and, in particular, flame-retardant polyolefin wrapping foil, preferably of polypropylene copolymer, the melt index of the polyolefin being below 5 g/10 min, preferably below 1 g/10 min, and in particular below 0.7 g/10 min.

The thickness of the foil of the invention is in the range from 30 to 180 μm, preferably 50 to 150 μm, in particular 55 to 100 μm. The surface may be textured or smooth. Preferably the surface is made slightly matt. This can be achieved through the use of a filler having a sufficiently high particle size or by means of an embossing roller on the calender.

In a preferred version the foil is provided on one or both sides with a pressure-sensitively adhesive layer, in order to simplify application, so that there is no need to fasten the wrapping foil at the end of the winding operation.

The wrapping foil of the invention is substantially free from volatile plasticizers such as DOP or TOTM, for example, and therefore has excellent fire performance and low emissions (plasticizer evaporation, fogging).

Unforeseeably and surprisingly for the skilled worker a foil of the invention can be produced. Remarkably, in addition, the thermal aging stability, in comparison to PVC as a high-performance material, is not poorer but instead is comparable or even better.

The wrapping foil of the invention has in machine direction a force at 1% elongation of 0.6 to 5 N/cm, preferably of 1 to 4 N/cm, and at 100% elongation a force of 2 to 20 N/cm, preferably of 3 to 10 N/cm.

In particular the force at 1% elongation is greater than or equal to 1 N/cm and the force at 100% elongation is less than or equal to 15 N/cm.

The 1% force is a measure of the rigidity of the foil, and the 100% force is a measure of the conformability when it is wound with sharp deformation as a result of high winding tension. The 100% force must also not be too low, since otherwise the tensile strength is inadequate.

In order to achieve these force values the wrapping foil preferably comprises at least one polyolefin, in particular a polypropylene, having a flexural modulus of less than 900 MPa, preferably 500 MPa or less, and in particular 80 MPa or less.

With further preference the polyolefin is a polypropylene copolymer which is from a process in which a PP homopolymer or random PP copolymer is reacted further with ethylene and propylene.

The preferred melt index of the polyolefin for calender processing is below 5 g/10 min, preferably below 1 g/10 min, and in particular below 0.7 g/10 min. For foils which are filled (with flame retardants, for example) the melt indices of the blends (compounds) additionally are below 5 g/10 min, preferably below 1 g/10 min, and in particular below 0.7 g/10 min.

The crystallite melting point of the polyolefin is between 120° C. and 166° C., preferably below 148° C., more preferably below 145° C. With very particular preference the crystallite melting point is. The polyolefin may be a soft ethylene homopolymer or ethylene or propylene copolymer.

The crystalline region of the copolymer is preferably a polypropylene having a random structure, in particular with an ethylene content of 6 to 10 mol %. A polypropylene random copolymer modified (with ethylene, for example) has a crystallite melting point, depending on the block length of the polypropylene and the comonomer content of the amorphous phase, of between 120° C. and 145° C. (this is the range for commercial products). Depending on molecular weight and tacticity, a polypropylene homopolymer is situated at between 163° C. to 166° C. If the homopolymer has a low molecular weight and has been modified with EP rubber (for example grafting, reactor blend), then the reduction in melting point leads to a crystallite melting point in the range from about 148° C. to 163° C. For the polypropylene copolymer of the invention, therefore, the preferred crystallite melting point is below 145° C. and is best achieved with a comonomer-modified polypropylene having random structure in the crystalline phase and copolymeric amorphous phase. The low melting point as compared with polypropylene homopolymer, of below 145° C., surprisingly has the advantage of easier processing. In the case of high-melting polypropylene polymers it is necessary to adapt the calender temperature to the melting point. With a low melting point, therefore, the calender temperature can be lowered. This proves, surprisingly, to be an advantage, since it is observed that, at a lower temperature, the problem of sticking of the melt on the calender rolls is considerably reduced.

In such copolymers, there is a relationship between the comonomer content of both the crystalline phase and the amorphous phase, the flexural modulus, and the 1% tension value of the wrapping foil produced therefrom. A high comonomer content in the amorphous phase allows a particularly low 1% force value. Surprisingly, the presence of comonomer in the hard crystalline phase as well has a positive effect on the flexibility of the filled foil.

There are no restrictions imposed on the monomer or monomers in the polyolefin, although preference is given to using α-olefins such as ethylene, propylene, 1-butylene, isobutylene, 4-methyl-1-pentene, hexene or octene. Copolymers having three or more comonomers are included for the purposes of this invention. Particularly preferred monomers for the polypropylene copolymer are propylene and ethylene. The polymer may additionally be modified by grafting, but not with polar comonomers such as maleic anhydride, vinyl esters or acrylate monomers, since these polar modified polypropylenes have a strong tendency to stick to the calendar rolls. The viscosity of the polymer melt proves not to be stable during the acrylic acid modification if metal hydroxides are present as flame retardants, since obviously ionomers are formed. By polypropylene copolymer is meant not only copolymers in the strict sense of polymer physics, such as block copolymers, for example, but also commercially customary thermoplastic PP elastomers with a wide variety of structures or properties. Materials of this kind may be prepared, for example, from PP homopolymers or random copolymers as a precursor by further reaction with ethylene and propylene in the gas phase in the same reactor or in subsequent reactors. When random copolymer starting material is used the monomer distribution of ethylene and propylene in the EP rubber phase which forms is more uniform, leading to improved mechanical properties. This is another reason why a polymer with a crystalline random copolymer phase is preferred for the wrapping foil of the invention.

For the preparation it is possible to employ conventional processes, examples including the gas-phase process, Cataloy process, Spheripol process, Novolen process, and Hypol process, which are described in Ullmann's Encyclopedia of Industrial Chemistry, 6th ed., Wiley-VCH 2002.

Suitable blend components are, for example, soft ethylene copolymers such as LDPE, LLDPE, metallocene-PE, EPM or EPDM with a density of 0.86 to 0.92 g/cm³, preferably from 0.86 to 0.88 g/cm³. Soft hydrogenated random or block copolymers of ethylene or (unsubstituted or substituted) styrene and butadiene or isoprene are also suitable for bringing the flexibility, the force at 1% elongation, and, in particular, the shape of the force/elongation curve of the wrapping foil into the optimum range. If in addition to the polypropylene copolymer of the invention a further ethylene or propylene copolymer is used it preferably has a specified melt index in the range of ±50% of the melt index of the polypropylene copolymer. This is without taking into account the fact that the melt index of ethylene copolymers is generally specified for 190° C. and not, as in the case of polypropylene, for 230° C. The blend components ought likewise to have very low melt indices.

By using ethylene copolymers with carbonyl-containing monomers such as ethylene acrylate (for example EMA, EBA, EEA, EAA) or ethylene-vinyl acetate it is possible, as the skilled worker is aware, to improve the fire performance of PP polymers. For the wrapping foils of the invention, however, these monomers are unwanted, since above about 10 or 20 phr they lead, owing to the polarity, to sticking of the foil on the calender. An exception are particulate crosslinked polar polymers such as acrylate impact modifiers or EVA dispersion powders with a polyvinyl alcohol shell.

Suitable flame retardants are essentially only halogen-free materials; that is, for example, fillers such as polyphosphates, carbonates and hydroxides of aluminum and/or of magnesium, borates, stannates, and nitrogen-based organic flame retardants. Preference is given to the hydroxides: in different embodiments, magnesium hydroxide has the advantage of safety against overheating (leads to decomposition), and aluminum hydroxide has the cost advantage.

Red phosphorus can be used but preferably is not (in other words, the amount is zero or not flame-effective), since its processing is hazardous (self-ignition of liberated phosphine during incorporation into the polymer by mixing; even in the case of coated phosphorus the amount of phosphine produced may still be enough to pose a health hazard to operatives). Moreover, when red phosphorus is used, it is not possible to produce colored products, but only black and brown products.

The flame retardant may have been provided with a coating, which in the case of the compounding operation may also be applied subsequently. Suitable coatings are silanes such as vinylsilane or free fatty acids (or derivatives thereof) such as stearic acid, silicates, borates, aluminum compounds, phosphates, titanates, or else chelating agents. The amount of free fatty acid or derivative thereof is preferably between 0.3% and 1% by weight.

Particular preference is given to ground magnesium hydroxides, examples being brucite (magnesium hydroxide), kovdorskites (magnesium hydroxide phosphate), hydromagnesite (magnesium hydroxycarbon), and hydrotalcite (magnesium hydroxide with aluminum and carbonate in the crystal lattice), particular preference being given to the use of brucite. Admixtures of magnesium carbonates such as, for example, dolomite [CaCO₃.MgCO₃, Mᵣ 184.41], magnesite (MgCO₃), and huntite [CaCO₃.3MgCO₃, Mᵣ 353.05] are allowable.

Particularly suitable magnesium hydroxide is that having an average particle size of more than 2 μm, the reference being to the median average (d₅₀ determined by laser light scattering by the Cilas method), and in particular of greater than or equal to 4 μm. The specific surface area (BET) is preferably below 4 m²/g (DIN 66131/66132). Customary wet-precipitated magnesium hydroxides are finely divided: in general the average particle size is 1 μm or below, the specific surface area 5 m²/g or more. The upper limit on the particle size distribution, d₉₇, is preferably not above 20 μm, so as to prevent the occurrence of holes in the foil and embrittlement. Therefore the magnesium hydroxide is preferably screened. The presence of particles with a diameter of 10 to 20 μm gives the foil a pleasing matt appearance.

The preferred particle morphology is irregularly spherical, similar to that of river pebbles. It is obtained preferably by grinding. Particular preference is given to magnesium hydroxide which has been produced by dry grinding in the presence of a free fatty acid, especially stearic acid. The fatty acid coating which forms enhances the mechanical properties of mixtures of magnesium hydroxide and polyolefins and reduces magnesium carbonate bloom. The use of a fatty acid salt (sodium stearate, for example) is likewise possible but has the drawback that the wrapping foil produced therefrom exhibits increased conductivity in the presence of moisture, which is deleterious for applications in which the wrapping foil also takes on the function of an insulating tape. In the case of synthetically precipitated magnesium hydroxide the fatty acid is always added in salt form, owing to the water solubility. This is another reason why for the wrapping foil of the invention a ground magnesium hydroxide is preferred over a precipitated one.

The amount of any flame retardant used is chosen such that the wrapping foil is flame-retardant, i.e., slow burning. The flame spread rate according to FMVSS 302 with a horizontal sample is preferably below 200 mm/min, more preferably below 100 mm/min; in one outstanding embodiment of the wrapping foil it is self-extinguishing under these test conditions. The oxygen index (LOI) is preferably above 20%, in particular above 23%, and more preferably above 27%. When magnesium hydroxide (natural and synthetic) is used the fraction is preferably 70 to 200 phr and in particular 110 to 180 phr.

Absent flame retarding requirements, no flame retardant is preferably used.

Further additives customary in the case of films, such as fillers, pigments, aging inhibitors, nucleating agents, impact modifiers or lubricants, et cetera, can be used to produce the wrapping foil. These additives are described for example in “Kunststoff Taschenbuch”, Hanser Verlag, edited by H. Saechtling, 28th edition or “Plastic Additives Handbook”, Hanser-Verlag, edited by H. Zweifel, 5th edition. In the remarks below, the respective CAS Reg. No. is used in order to avoid chemical names that are difficult to understand.

A further prerequisite for adequate short-term thermal stability and heat resistance is a sufficient melting point on the part of the polyolefin (at least 120° C.), crosslinking, or adequate mechanical stability of the melt above the crystallite melting point. The latter can be achieved as a result of the very low melt index according to the invention.

In order to achieve stable film processing properties and effective aging stability of the winding tape, the use of the correct aging inhibitors is assigned a particular role. Advantageously a primary antioxidant and a secondary antioxidant ought to be used. The winding tapes of the invention advantageously contain at least 4 phr of a primary antioxidant or, preferably, at least 0.3 phr, in particular at least 1 phr, of a combination of primary and secondary antioxidants, it also being possible for the primary and secondary antioxidant function to be united in one molecule, and the amounts stated not including optional stabilizers such as metal deactivators or light stabilizers.

In one preferred embodiment the fraction of secondary antioxidant is more than 0.3 phr. Stabilizers for PVC products cannot be transferred to polyolefins. Secondary antioxidants break down peroxides and are therefore used as part of aging inhibitor packages in the case of diene elastomers. Surprisingly it has been found that a combination of primary antioxidants (for example, sterically hindered phenols or C-radical scavengers such as CAS 181314-48-7) and secondary antioxidants (for example, sulfur compounds, phosphites or sterically hindered amines), it also being possible for both functions to be united in one molecule, achieves the stated object in the case of diene-free polyolefins such as polypropylene as well. Particularly preferred is the combination of primary antioxidant, preferably sterically hindered phenols having a molecular weight of more than 500 g/mol (especially >700 g/mol), with a phosphitic secondary antioxidant (particularly with a molecular weight>600 g/mol). Phosphites or a combination of primary and two or more secondary aging inhibitors have not been used to date in wrapping foils comprising polypropylene copolymers. The combination of a low-volatility primary phenolic antioxidant and one secondary antioxidant each from the class of the sulfur compounds (preferably with a molecular weight of more than 400 g/mol, especially >500 g/mol) and from the class of the phosphites is suitable, and in this case the phenolic, sulfur-containing and phosphitic functions need not be present in three different molecules; instead, more than one function may also be united in one molecule.

### EXAMPLES

Phenolic Function:

CAS 6683-19-8, 2082-79-3, 1709-70-2, 36443-68-2, 1709-70-2, 34137-09-2, 27676-62-6, 40601-76-1, 31851-03-3, 991-84-4

Sulfur-Containing Function:

CAS 693-36-7, 123-28-4, 16545-54-3, 2500-88-1

Phosphitic Function:

CAS 31570-044, 26741-53-7, 80693-00-1, 140221-14-3, 119345-01-6, 3806-34-6, 80410-33-9, 14650-60-8, 161717-32-4

Phenolic and Sulfur-Containing Function:

CAS 41484-35-9, 90-66-4, 110553-27-0, 96-96-5, 41484

Phenolic and Aminic Function:

CAS 991-84-4, 633843-89-0

Aminic Function:

CAS 52829-07-9, 411556-26-7, 129757-67-1, 71878-19-8, 65447-77-0

The combination of CAS 6683-19-8 (for example, Irganox 1010) with thiopropionic esters CAS 693-36-7 (Irganox PS 802) or 123-28-4 (Irganox PS 800) with CAS 31570-04-4 (Irgafos 168) is particularly preferred. Preference is given to a combination in which the fraction of secondary antioxidant exceeds that of the primary antioxidant. In addition it is possible to add metal deactivators in order to complex traces of heavy metal, which may catalytically accelerate aging. Examples are CAS 32687-78-8, 70331-94-1, 6629-10-3, ethylenediaminetetraacetic acid, N,N′-disalicylidene-1,2-diaminopropane or commercial products such as 3-(N-salicylol)amino-1,2,4-triazole (Palmarole ADK STAB CDA-1), N,N′-bis[3-(3′,5′-di-tert-butyl-4′-hydroxyphenyl)propionyl]hydrazide (Palmarole MDA. P.10) or 2,2′-oxamido-bis[ethyl 3-(tert-butyl-4-hydroxyphenyl)propionate] (Palmarole MDA.P.11).

The selection of the stated aging inhibitors is particularly important for the wrapping foil of the invention, since with phenolic antioxidants, alone or even in combination with sulfur-containing costabilizers, it is not generally possible to obtain products which conform to the art. In calender processing, where on the rolls a relatively long-lasting ingress of atmospheric oxygen is unavoidable, the concomitant use of phosphite stabilizers proves virtually inevitable for sufficient thermal aging stability on the part of the product. For the phosphite stabilizer an amount of at least 0.1 phr, preferably at least 0.3 phr, is preferred. Particularly when using natural magnesium hydroxides such as brucite it is possible, as a result of migratable metal impurities such as iron, manganese, chromium or copper, for aging problems to arise, which can be avoided only through abovementioned knowledge of the correct combination and amount of aging inhibitors. As remarked above, ground brucite has a number of technical advantages over precipitated magnesium hydroxide, so that the combination with antioxidants as described is particularly sensible. For applications involving a high temperature load (for example, for use as cable wrapping foil in the engine compartment of motor vehicles or as an insulating winding on magnet coils in TV or PC screens) an embodiment is preferred which besides the antioxidants also includes a metal deactivator.

The wrapping foil of the invention is preferably pigmented, especially black. Coloring may be carried out in the base film, in the adhesive layer or in any other layer. The use of organic pigments or dyes in the wrapping foil is possible, preference being given to the use of carbon black. The carbon black fraction is preferably at least 5 phr, in particular at least 10 phr, since surprisingly it proves to have a significant influence on the fire performance. As carbon black it is possible to use all of the types, such as gas black, acetylene black, furnace black and lamp black, for example, preference being given to lamp black, despite the fact that furnace blacks are usual for the coloring of films. For optimum aging, preference is given to carbon black grades having a pH in the range from 6 to 8.

The wrapping foil is produced on a calender. This process is described for example in Ullmann's Encyclopedia of Industrial Chemistry, 6th ed., Wiley-VCH 2002. The compound comprising the main components or all of the components can be produced in a compounder such as kneading apparatus (for example, a plunger compounder) or extruder (for example, a twin-screw or planetary roll extruder) and then converted into a solid form (granules, for example) which are then melted in an extruder, compounder or roll mill of a calender installation, and processed further. High amounts of filler produce slight inhomogeneities (defects) which sharply reduce the breakdown voltage. The mixing operation must therefore be performed thoroughly enough that the foil manufactured from the compound attains a breakdown voltage of at least 3 kV/100 μm, preferably at least 5 kV/100 μm. It is preferred to produce compound and foil in one operation. The melt is supplied from the compounder directly to the calender, but may if desired pass through auxiliary installations such as filters, metal detectors or roll mills. In the course of the production operation the foil is oriented as little as possible, in order to achieve good hand tearability, low force value at 1% elongation, and low contraction.

The contraction of the wrapping foil in machine direction after hot storage (30 minutes in an oven at 125° C., lying on a layer of talc) is less than 5%, preferably less than 3%.

The mechanical properties of the wrapping foil of the invention are situated preferably in the following ranges:
breaking elongation in md (machine direction) from 300% to 1000%, more preferably from 500% to 800%,
breaking strength in md in the range from 4 to 15, more preferably from 5 to 8 N/cm,
   the foil having been cut to size using sharp blades in order to determine the data.

In the preferred embodiment the wrapping foil is provided on one or both sides, preferably one side, with a sealing or pressure-sensitive adhesive coating, in order to avoid the need for the wound end to be fixed by means of an adhesive tape, wire or knot. The amount of the adhesive layer is in each case 10 to 40 g/m², preferably 18 to 28 g/m² (that is, the amount after removal of water or solvent, where necessary; the numerical values also correspond approximately to the thickness in μm). In one case with adhesive coating the figures given here for the thickness and for mechanical properties dependent on thickness refer exclusively to the polypropylene-containing layer of the wrapping foil, without taking into account the adhesive layer or other layers which are advantageous in connection with adhesive layers. The coating need not cover the whole area, but may also be configured for partial coverage. An example that may be mentioned is a wrapping foil with a pressure-sensitively adhesive strip at each of the side edges. This strip can be cut off to form approximately rectangular sheets, which are adhered to the cable bundle by one adhesive strip and are then wound until the other adhesive strip can be bonded to the reverse of the wrapping foil. A hoselike envelope of this kind, similar to a sleeve form of packaging, has the advantage that there is virtually no deterioration in the flexibility of the cable harness as a result of the wrapping.

Suitable adhesives include all customary types, especially those based on rubber. Rubbers of this kind may be, for example, homopolymers or copolymers of isobutylene, of 1-butene, of vinyl acetate, of ethylene, of acrylic esters, of butadiene or of isoprene. Particularly suitable formulas are those based on polymers themselves based on acrylic esters, vinyl acetate or isoprene.

In order to optimize the properties it is possible for the self-adhesive mass employed to have been blended with one or more additives such as tackifiers (resins), plasticizers, fillers, flame retardants, pigments, UV absorbers, light stabilizers, aging inhibitors, photoinitiators, crosslinking agents or crosslinking promoters. Tackifiers are, for example, hydrocarbon resins (for example, polymers based on unsaturated C5 or C9 monomers), terpene-phenolic resins, polyterpene resins formed from raw materials such as α- or β-pinene, for example, aromatic resins such as coumarone-indene resins, or resins based on styrene or α-methylsytrene, such as rosin and its derivatives, disproportionated, dimerized or esterified resins, for example, such as reaction products with glycol, glycerol or pentaerythritol, for example, to name only a few, and also further resins (as recited, for example, in Ullmanns Enzylopädie der technischen Chemie, Volume 12, pages 525 to 555 (4th ed.), Weinheim). Preference is given to resins without easily oxidizable double bonds, such as terpene-phenolic resins, aromatic resins, and, with particular preference, resins prepared by hydrogenation, such as, for example, hydrogenated aromatic resins, hydrogenated polycyclopentadiene resins, hydrogenated rosin derivatives or hydrogenated terpene resins.

Examples of suitable fillers and pigments include titanium dioxide, calcium carbonate, zinc carbonate, zinc oxide, silicates or silica. Suitable admixable plasticizers are, for example, aliphatic, cycloaliphatic and aromatic mineral oils, diesters or polyesters of phthalic acid, trimellitic acid or adipic acid, liquid rubbers (for example, nitrile rubbers or polyisoprene rubbers of low molecular mass), liquid polymers of butene and/or isobutene, acrylic esters, polyvinyl ethers, liquid resins and soft resins based on the raw materials of tackifier resins, lanolin and other waxes or liquid silicones. Examples of crosslinking agents include isocyanates, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid. Examples of aging inhibitors include sterically hindered phenols, which are known, for example, under the trade name Irganox™.

Crosslinking is advantageous, since the shear strength (expressed as holding power, for example) is increased and hence the tendency toward deformation in the rolls on storage (telescoping or formation of cavities, also called gaps) is reduced. Exudation of the pressure-sensitive adhesive mass, as well, is reduced. This is manifested in tack-free side edges of the rolls and tack-free edges in the case of the wrapping foil wound spirally around cables. The holding power is preferably more than 150 min.

The bond strength to steel ought to be situated in the range from 1.5 to 3 N/cm.

In summary the preferred embodiment has on one side a solvent-free self-adhesive mass which has come about as a result of melt coating or dispersion coating. Dispersion adhesives are preferred, especially polyacrylate-based ones.

Advantageous is the use of a primer layer between wrapping foil and adhesive mass in order to improve the adhesion of the adhesive mass on the wrapping foil and hence to prevent transfer of adhesive to the reverse of the foil during unwinding of the rolls.

Primers which can be used are the known dispersion- and solvent-based systems based for example on isoprene or butadiene rubber and/or cyclo rubber. Isocyanates or epoxy resin additives improve the adhesion and in part also increase the shear strength of the pressure-sensitive adhesive. Physical surface treatments such as flaming, corona or plasma, or coextrusion layers, are likewise suitable for improving the adhesion. Particular preference is given to applying such methods to solvent-free adhesive layers, especially those based on acrylate.

The reverse face can be coated with known release agents (blended where appropriate with other polymers). Examples are stearyl compounds (for example, polyvinyl stearylcarbamate, stearyl compounds of transition metals such as Cr or Zr, and ureas formed from polyethyleneimine and stearyl isocyanate), polysiloxanes (for example, as a copolymer with polyurethanes or as a graft copolymer on polyolefin), and thermoplastic fluoropolymers. The term stearyl stands as a synonym for all linear or branched alkyls or alkenyls having a C number of at least 10, such as octadecyl, for example.

Descriptions of the customary adhesive masses and also reverse-face coatings and primers are found for example in “Handbook of Pressure Sensitive Adhesive Technology”, D. Satas, (3rd edition). The stated reverse-phase primer coatings and adhesive coatings are possible in one embodiment by means of coextrusion.

The configuration of the reverse face of the foil may also, however, serve to increase the adhesion of the adhesive mass to the reverse face of the wrapping foil (in order to control the unwind force, for example). In the case of polar adhesives such as those based on acrylate polymers, for example, the adhesion of the reverse face to a foil based on polypropylene polymers is often not sufficient. For the purpose of increasing the unwind force an embodiment is claimed in which the polar reverse-face surfaces are achieved by corona treatment, flame pretreatment or coating/coextrusion with polar raw materials. Claimed alternatively is a wrapping foil in which the log product has been conditioned (stored under hot conditions) prior to slitting. Both processes may also be employed in combination. The wrapping foil of the invention preferably has an unwind force of 1.2 to 6.0 N/cm, very preferably of 1.6 to 4.0 N/cm, and in particular 1.8 to 2.5 N/cm, at an unwind speed of 300 mm/min. The conditioning is known in the case of PVC winding tapes, but for a different reason. In contradistinction to partially crystalline polypropylene copolymer films, plasticized PVC films have a broad softening range and, since the adhesive mass has a lower shear strength, owing to the migrative plasticizer, PVC winding tapes tend toward telescoping. This unadvantageous deformation of the rolls, in which the core is forced out of the rolls to the side, can be prevented if the material is stored for a relatively long time prior to slitting or is subjected briefly to conditioning (storage under hot conditions for a limited time). In the case of the process of the invention, however, the purpose of the conditioning is to increase the unwind force of material with an a polar polypropylene reverse face and with a polar adhesive mass, such as polyacrylate or EVA, since this adhesive mass exhibits extremely low reverse-face adhesion to polypropylene in comparison to PVC. An increase in the unwind force by conditioning or physical surface treatment is unnecessary with plasticized PVC winding tapes, since the adhesive masses normally used possess sufficiently high adhesion to the polar PVC surface. In the case of polyolefin wrapping foils the significance of reverse-face adhesion is particularly pronounced, since because of the higher force at 1% elongation (owing to the flame retardant and the absence of conventional plasticizers) a much higher reverse-face adhesion, and unwind force, is necessary, in comparison to PVC film, in order to provide sufficient stretch during unwind for the application. The preferred embodiment of the wrapping foil is therefore produced by conditioning or physical surface treatment in order to achieve outstanding unwind force and stretch during unwind, the unwind force at 300 mm/min being higher preferably by at least 50% than without such a measure.

In the case of an adhesive coating, the wrapping foil is preferably stored beforehand for at least 3 days, more preferably at least 7 days, prior to coating, in order to achieve post-crystallization, so that the rolls do not acquire any tendency toward telescoping (probably because the foil contracts on crystallization). Preferably the foil on the coating installation is guided over heated rollers for the purpose of leveling (improving the planar lie), which is not customary for PVC wrapping foils.

Normally, polyethylene and polypropylene films cannot be torn into or torn off by hand. As partially crystalline materials, they can be stretched with ease and therefore have a high breaking elongation, generally of well above 500%. When attempts are made to tear such films what occurs, rather than tearing, is stretching. Even high forces may not necessarily overcome the typically high rupture forces. Even if this does occur, the tear which is produced does not look good and cannot be used for bonding, since a thin, narrow “tail” is formed at either end. Nor can this problem be eliminated by means of additives, even if large amounts of fillers reduce the breaking elongation. If polyolefin films are biaxially stretched the breaking elongation is reduced by more than 50%, to the benefit of tearability. Attempts to transfer this process to soft wrapping foils failed, however, since there is a considerable increase in the 1% force value and the force/elongation curve becomes considerably more steep. A consequence of this is that the flexibility and conformability of the wrapping foil are drastically impaired. Moreover, it is found that foils with such high filler content are virtually impossible to stretch in industrial production, owing to a high number of tears.

Surprisingly, a solution has been found by means of the slitting process when the rolls are being converted. In the course of the production of rolls of wrapping foils, rough slit edges are produced which, viewed microscopically, form cracks in the foil, which then evidently promote tear propagation. This is possible in particular through the use of a crush slitting with blunt rotating knives, or rotating knives with a defined sawtooth, on product in bale form (jumbo rolls, high-length rolls) or by means of a parting slitting with fixed blades or rotating knives on product in log form (rolls in production width and conventional selling length). The breaking elongation can be adjusted by appropriate grinding of the blades and knives. Preference is given to the production of log product with parting slitting using blunt fixed blades. By cooling the log rolls sharply prior to slitting it is possible to improve still further the formation of cracks during the slitting operation. In the preferred embodiment the breaking elongation of the specially slit wrapping foil is lower by at least 30% than when it is slit with sharp blades. In the case of the particularly preferred foils that are slit with sharp blades the breaking elongation is 500% to 800%; in the embodiment of the foil whose side edges are subjected to defined damage in the course of slitting, it is between 200% and 500%.

In order to increase the unwind force, the log product can be subjected to storage under hot conditions beforehand. Conventional winding tapes with cloth, web or film carriers (PVC for example) are slit by shearing (between two rotating knives), parting (fixed or rotating knives are pressed into a rotating log roll of the product), blades (the web is divided in the course of passage through sharp blades) or crush (between a rotating knife and a roller).

The purpose of slitting is to produce saleable rolls from jumbo or log rolls, but not to produce rough slit edges for the purpose of easier hand tearability. In the case of PVC wrapping foils the parting slit is entirely conventional, since the process is economic in the case of soft foils. In the case of PVC material, however, hand tearability is given, since, unlike polypropylene, PVC is amorphous and therefore is not stretched on tearing, only elongated a little. So that the PVC foils do not tear too easily, attention must be paid to appropriate gelling in the course of production of the foil, which goes against an optimum production speed; in many cases, therefore, instead of standard PVC with a K value of 63 to 65, material of higher molecular weight is used, corresponding to K values of 70 or more. With the polypropylene wrapping foils of the invention, therefore, the reason for the parting is different than in the case of those made of PVC.

The wrapping foil of the invention is outstandingly suitable for the wrapping of elongate material such as ventilation pipes, field coils or cable looms in vehicles.

The wrapping foil of the invention is likewise suitable for other applications, such as, for example, for ventilation pipes in air-conditioning installation, since the high flexibility ensures good conformability to rivets, beads and folds. Present-day occupational hygiene and environmental requirements are met, because halogenated raw materials are not used; the same also applies to volatile plasticizers, even though the amounts are so small that the fogging number is more than 90%. Absence of halogen is extremely important for the recovery of heat from wastes which includes such winding tapes (for example, incineration of the plastics fraction from vehicle recycling). The product of the invention is halogen-free in the sense that the halogen content of the raw materials is so low that it plays no part in the flame retardancy. Halogens in trace amounts, such as may occur as a result of impurities in-process additives (fluoroelastomer) or as residues of catalysts (from the polymerization of polymers, for example), remain disregarded. The omission of halogens is accompanied by the quality of easy flammability, which is not in accordance with the safety requirements in electrical applications such as household appliances or vehicles. The problem of deficient flexibility when using customary PVC substitute materials such as polypropylene, polyethylene, polyesters, polystyrene, polyamide or polyimide for the wrapping foil is solved in the underlying invention not by means of volatile plasticizers but instead by the use of a polyolefin, preferably a mixture of a PP copolymer with a polyolefin of low flexural modulus or the use of a PP polymer with a low flexural modulus.

### Test Methods

The measurements are carried out under test conditions of 23±1° C. and 50±5% relative humidity.

The density of the polymers is determined in accordance with ISO 1183 and the flexural modulus in accordance with ISO 178 and expressed in g/cm³ and MPa respectively. (The flexural modulus in accordance with ASTM D790 is based on different specimen dimensions, but the result is comparable as a number.) The melt index is tested in accordance with ISO 1133 and expressed in g/10 min. The test conditions are, as is the market standard, 230° C. and 2.16 kg for polymers containing crystalline polypropylene and 190° C. and 2.16 kg for polymers containing crystalline polyethylene. The crystallite melting point (Tcr) is determined by DSC in accordance with MTM 15902 (Basell method) or ISO 3146.

The average particle size of the filler is determined by means of laser light scattering by the Cilas method, the critical figure being the d₅₀ median value.

The specific surface area (BET) of the filler is determined in accordance with DIN 66131/66132.

The tensile elongation behavior of the wrapping foil is determined on type 2 test specimens (rectangular test strips 150 mm long and, as far as possible, 15 mm wide) in accordance with DIN EN ISO 527-312/300 with a test speed of 300 mm/min, a clamped length of 100 mm and a pretensioning force of 0.3 N/cm. In the case of specimens with rough slit edges, the edges should be tidied up with a sharp blade prior to the tensile test. In deviation from this, for determining the force or tension at 1% elongation, measurement is carried out with a test speed of 10 mm/min and a pretensioning force of 0.5 N/cm on a model Z 010 tensile testing machine (manufacturer: Zwick). The testing machine is specified since the 1% value may be influenced somewhat by the evaluation program. Unless otherwise indicated, the tensile elongation behavior is tested in machine direction (MD). The force is expressed in N/strip width and the tension in N/strip cross section, the breaking elongation in %. The test results, particularly the breaking elongation (elongation at break), must be statistically ascertained by means of a sufficient number of measurements.

The bond strengths are determined at a peel angle of 180° in accordance with AFERA 4001 on test strips which (as far as possible) are 15 mm wide. AFERA standard steel plates are used as the test substrate, in the absence of any other substrate being specified.

The thickness of the wrapping foil is determined in accordance with DIN 53370. Any pressure-sensitive adhesive layer is subtracted from the total thickness measured.

The holding power is determined in accordance with PSTC 107 (10/2001), the weight being 20 N and the dimensions of the bond area being 20 mm in height and 13 mm in width.

The unwind force is measured at 300 mm/min in accordance with DIN EN 1944.

The hand tearability cannot be expressed in numbers, although breaking force, breaking elongation and impact strength under tension (all measured in machine direction) are of substantial influence.

Evaluation:

+++=very easy,

++=good,

+=still processable,

−=difficult to process,

−−=can be torn only with high application of force; the ends are untidy,

−−−=unprocessable

The fire performance is measured in accordance with MVSS 302 with the sample horizontal. In the case of a pressure-sensitive adhesive coating on one side, that side faces up. As a further method, testing of the oxygen index (LOI) is performed. Testing for this purpose takes place under the conditions of JIS K 7201.

The heat stability is determined by a method based on ISO/DIN 6722. The oven is operated in accordance with ASTM D 2436-1985 with 175 air changes per hour. The test time amounts to 3000 hours. Test temperatures chosen are 85° C. (class A), 105° C. (similar to class B but not 100° C.), and 125° C. (class C). Accelerated aging takes place at 136° C., with the test being passed if the elongation at break is still at least 100% after 20 days' aging.

In the case of compatibility testing, storage under hot conditions is carried out on commercially customary leads (cables) with polyolefin insulation (polypropylene or radiation-crosslinked polyethylene) for motor vehicles. For this purpose, specimens are produced from 5 leads with a cross section of 3 to 6 mm² and a length of 350 mm, with wrapping foil, by wrapping with a 50% overlap. After the aging of the specimens in a forced-air oven for 3000 hours (conditions as for heat stability testing), the samples are conditioned at 23° C. and in accordance with ISO/DIN 6722 are wound by hand around a mandrel; the winding mandrel has a diameter of 5 mm, the weight has a mass of 5 kg, and the winding rate is 1 rotation per second. The specimens are subsequently inspected for defects in the wrapping foil and in the wire insulation beneath the wrapping foil. The test is failed if cracks can be seen in the wire insulation, particularly if this is apparent even before bending on the winding mandrel. If the wrapping foil has cracks or has melted in the oven, the test is likewise classed as failed. In the case of the 125° C. test, specimens were in some cases also tested at different times. The test time is 3000 hours unless expressly described otherwise in an individual case.

The short-term thermal stability is measured on cable bundles comprising 19 wires of type TW with a cross section of 0.5 mm², as described in ISO 6722. For this purpose the wrapping foil is wound with a 50% overlap onto the cable bundle, and the cable bundle is bent around a mandrel with a diameter of 80 mm and stored in a forced-air oven at 140° C. After 168 hours the specimen is removed from the oven and examined for damage (cracks).

To determine the heat resistance the wrapping foil is stored at 170° C. for 30 minutes, cooled to room temperature for 30 minutes and wound with at least 3 turns and a 50% overlap around a mandrel with a diameter of 10 mm. Thereafter the specimen is examined for damage (cracks).

In the case of the low-temperature test, the above-described specimen is cooled to −40° C. for 4 hours, in a method based on ISO/DIS 6722, and the sample is wound by hand onto a mandrel with a diameter of 5 mm. The specimens are examined for defects (cracks) in the adhesive tape.

The breakdown voltage is measured in accordance with ASTM D 1000. The number taken is the highest value for which the specimen withstands this voltage for one minute. This number is converted to a sample thickness of 100 μm.

### EXAMPLE

A sample 200 μm thick withstands a maximum voltage of 6 kV for one minute: the calculated breakdown voltage amounts to 3 kV/100 μm.

The fogging number is determined in accordance with DIN 75201 A.

1. A halogen-free calendered, and, optionally, flame-retardant polyolefin wrapping foil, wherein the melt index of the polyolefin is below 5 g/10 min.

2. The wrapping foil of claim 1, wherein a blend (compound) of the foil has a melt index below 5 g/10 min.

3. The wrapping foil of claim, which comprises a fraction of flame retardant of at least 100 phr.

4. The wrapping foil of claim 1, which has a thickness of 30 to 180 μm, and exhibits
a force in a machine direction at 1% elongation of 0.6 to 5 N/cm,
a force at 100% elongation of 2 to 20 N/cm, and/or
a crystallite melting point of the polypropylene copolymer of less than 166° C.

5. The wrapping foil of claim 1, wherein the polyolefin is a polypropylene copolymer.

6. The wrapping foil of claim 1, which comprises polypropylene polymer and also ethylene-propylene copolymers from the classes of EPM and EPDM polymers.

7. The wrapping foil of claim 1, which comprises at least one polypropylene having a flexural modulus of less than 900 MPa, and/or a crystallite melting point of between 120° C. and 166° C.

8. The wrapping foil of claim 1, which has on one or both sides, a layer of adhesive, and optionally a primer layer between film and adhesive layer,
the amount of the adhesive layer being in each case 10 to 40 g/m², and the adhesive exhibiting,
a bond strength to steel of 1.5 to 3 N/cm,
an unwind force of 1.2 to 6.0 N/cm at 300 mm/min unwind speed, and/or
a holding power of more than 150 min.

9. The wrapping foil of claim 1, which comprises a solvent-free pressure-sensitive adhesive which is produced by coextrusion, melt coating or dispersion coating, this adhesive being joined to a surface of the carrier foil by means of flame or corona pretreatment or of an adhesion promoter layer which is applied by coextrusion or coating.

10. The wrapping foil of claim 1, which exhibits an oxygen index (LOI) above 20%.

11. The wrapping foil of claim 1, which exhibits a flame spread rate in accordance with FMVSS 302 with a horizontal sample of below 200 mm/min, and, optionally, under these test conditions the sample is self-extinguishing.

12. The wrapping foil of claim 1, which comprises a fraction of carbon black of at least 5 phr, the carbon black optionally having a pH of 6 to 8.

13. A method of bundling, protecting, labeling, insulating or sealing ventilation pipes or wires or cables and for sheathing cable harnesses in vehicles or field coils for picture tubes comprising wrapping said pipes, wires or cables with a wrapping foil according to claim 1.
